(19) United States
(12) Patent Application Publication
(10) Pub. No.: US 2003/0023895 A1
(43) Pub. Date: Jan. 30, 2003

(54) Peripheral failover system

(76) Inventors: Manish Sinha, Cupertino, CA (US); Satish M. Mohan, Sunnyvale, CA (US); Christian J.D. Jacques, Gatineau (CA)

Correspondence Address: Davidson, Davidson & Kappel, LLC, 485 Seventh Avenue, 14th Floor, New York, NY, 10018, US

(21) Appl. No.: 09/916,957

(22) Filed: Jul. 27, 2001

(51) Int. Cl. G06F 11/20

(52) U.S. Cl. 714/5

(57) ABSTRACT

A method for performing peripheral failover includes the steps of identifying a virtual device associated with a first slot of a plurality of slots, identifying a backup I/O component in a second slot of the plurality of slots, and disassociating the virtual device with the first slot and associating the virtual device with the second slot.

### BACKGROUND

A computer system may include processor(s) and I/O device(s) that interact with each other. Therefore, a failure of an I/O device may impact the operation of the processor(s) that require the services of the failed I/O device.

### SUMMARY OF THE INVENTION

In accordance with a first embodiment of the present invention, a method is provided comprising the steps of identifying a virtual device associated with a first slot of a plurality of slots, identifying a backup I/O component in a second slot of the plurality of slots, disassociating the virtual device with the first slot and associating the virtual device with the second slot.

In accordance with a second embodiment of the present invention, a system is provided which includes a virtual device table, a failure detection component, a disconnect component, and a connect component. The virtual device table maintains an association between a plurality of virtual devices and a plurality of slots in a chassis and the failure detection component is capable of detecting a failure of an I/O component in one of the plurality of slots. The disconnect component is capable of disassociating the I/O component from a corresponding one of the virtual devices associated with the one of the plurality of slots holding the I/O component, and identifying a backup I/O component in another one of the plurality of slots based upon the virtual device table. The connect component is capable of associating the corresponding one of the virtual devices with the backup I/O component.

In accordance with a third embodiment of the present invention, a system is provided that includes a peripheral failover system and a plurality of I/O components secured within respective slots in a chassis. At least two of the plurality of I/O components form a peripheral failover pair. The peripheral failover system detects a failure of one I/O component in the peripheral failover pair, disassociates a virtual device from the failed I/O component and associates the virtual device with the other I/O component in the peripheral failover pair.

### BRIEF DESCRIPTION OF THE DRAWINGS

FIG. 1 shows an exemplary Peripheral Failover System in accordance with an embodiment of the present invention.

FIG. 2 shows a state diagram for an exemplary virtual device for the system of FIG. 1.

### DETAILED DESCRIPTION OF THE PREFERRED EMBODIMENTS

In accordance with an embodiment of the present invention, a peripheral failover system (PFS) is provided. The PFS allows a primary I/O component to be failed over to a backup I/O component. In this regard, an I/O component can be of any conventional type, including ethernet cards, serial ports, parallel ports, and the like. In the discussion that follows, the term “primary” I/O component is meant to refer to the initially active I/O component, whereas the term “backup” I/O component is meant to refer to the I/O component that is initially in an inactive state. The primary I/O component and the backup I/O component can be collectively referred to as a peripheral failover pair.

A failover of an I/O component can be triggered in a number of ways. For example, if a system includes a primary I/O component in a first “slot” on a bus and a backup I/O component on a second slot on the bus, and the primary I/O component fails, the system will automatically failover to the backup I/O component. However, in the context of the PFS, failover can also occur in a “hot swap” procedure when no backup I/O component is resident in a slot. In this regard, a primary I/O component can failover by being removed from its slot and replaced with a backup I/O component inserted in the same slot. In the context of the present invention, this will be referred to as a “hot swap” failover.

As one of ordinary skill in the art will appreciate, a “hot swap” occurs when a device (such as an I/O component) is removed from a slot and replaced with another similar device without rebooting the system. Exemplary specification for Hot Swap Management Systems (HSMSs) which can implement a hot swap of I/O components include, for example, the CompactPCI Hot Swap Specification, PICMG 2.1, R1.0 distributed by the PCI® Industrial Computer Manufacturers Group (PICMG), incorporated herein by reference. As the PFS in accordance with an embodiment of the present invention can be implemented with a conventional HSMS, the details of such a system, including, for example, the manner in which device removal and replacement is detected, will not be addressed herein.

In order to implement failover of I/O components, a PFS in accordance with an embodiment of the present invention utilizes a virtual device. The virtual device is a software representation of a physical device (in this case an I/O component). In a conventional system, all drivers are assigned to physical devices during the “bootup” procedure for the system, and the connection between a driver and its corresponding physical device cannot be subsequently changed without shutting down the system. With the PFS, the system is booted up with virtual devices and virtual drivers, allowing the actual drivers to be dynamically connected and disconnected to physical devices via the virtual device. In the discussion that follows, the actual drivers will simply be referred to as “drivers”, whereas the term “virtual driver” will be used to refer to virtual drivers.

In accordance with a preferred embodiment of a PFS, a system configuration data structure, in this example a system configuration table (SCT), is used to provide information on I/O devices that require failover services from the PFS. The SCT has an entry for each slot on the system chassis. In each entry, the user specifies a list of I/O devices expected on that slot, and the I/O parameters needed to configure those devices.

The relevant items in an exemplary SCT entry for an ethernet card might include the following:

“Slot01”, “n:192.103.55.225:255.255.255.0”, SYS_CARD_IO_PRI, “Slot02”

The first item (“Slot01”) identifies the slot name on the chassis and the second item specifies an ethernet device (type “n”), which is to be assigned an IP address 192.103.55.255 and a netmask of 255.255.255.0. A similar format for specifying device parameters can be used to support other device types (e.g., “s” for SCSI, “sp” for serial port, “pp” for parallel port.). These device dependent parameters are used in conjunction with the configuration of the device. The third item in the table entry indicates that slot “Slot01” holds the primary I/O device, and the fourth item specifies the slot for the backup I/O component (in this case “Slot02”). Therefore, if the card in “Slot01” is extracted from the system or otherwise fails, the PFS will failover to the I/O component on “Slot02”.

Generally, the entry for the backup slot is configured symmetrically to the primary slot so that the backup slot fails over to the primary slot. Assuming this is the case, the entry for slot “Slot02” would be as follows:

“Slot02”, “n:192.103.55.225:255.255.255.0”, SYS_CARD_IO_BKP, “Slot01”

In this regard, during system initialization, a virtual device is generated for each primary I/O component, and the primary I/O component is connected to a driver via this virtual device. Virtual devices are not generated for backup I/O components during initialization. If a failover occurs, the virtual device will be disconnected from the primary I/O component and its driver, and then connected to the backup I/O component and its driver. When the virtual device is disconnected from the driver for the primary I/O component, it is automatically connected to a virtual driver. The virtual driver is then disconnected from the virtual device when the virtual device is ready to be connected to the driver for the backup I/O component. Through the use of the virtual driver, the PFS allows a processor to receive a driver response even when no physical device is present. As one of ordinary skill in the art will appreciate, this provides the opportunity to replace an I/O component and its driver without affecting the processor.

It should be noted that the system assumes that users will construct their systems in such a way that the backup slot will have similar devices (usually identical) to the primary slot. In this regard, two devices would be considered “similar” if they fall in the same class of I/O. Such classes include END (enhanced network device) type devices, block type devices, serial type devices, etc. In this regard, a virtual driver is created in the system for each I/O type (i.e. class of I/O). At the time of creation of the virtual devices for each primary I/O device, each such virtual device is associated with a virtual driver of the applicable I/O type. With this architecture, it is possible to failover from one END device to another END device in the manner described below. Specific embodiments of the PFS may place further restrictions based on other criteria like the component vendor/manufacturer.

During system initialization, the PFS reads the SCT and builds its own internal representation of the SCT called the Virtual Device Table (VDT). The VDT is an internal virtual device data structure which maintains relevant state information for a given virtual device. It constructs virtual devices for each primary I/O device specified by the user in the SCT and populates the VDT with these virtual devices. As noted above, virtual devices are not created for backup devices, since the same virtual device is used when failover occurs.

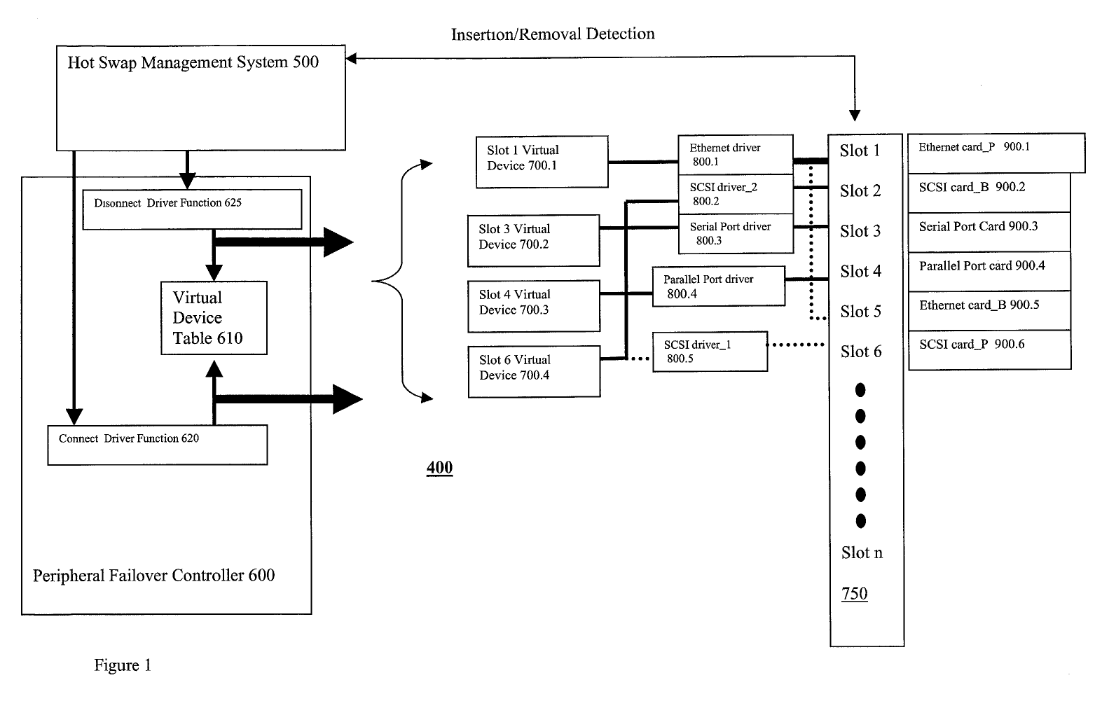

Referring to FIG. 1, an exemplary PFS system 400 is shown having a chassis 750 with n slots, six of which have I/O devices mounted therein. Specifically, slot 1 is shown with a primary ethernet card 900.1 (Ethernet card_P), slot 2 is shown with a backup SCSI card 900.2 (SCSI card_B), slot 3 is shown with a serial port card 900.3, slot 4 is shown with a parallel port card 900.4, slot 5 is shown with a backup ethernet card 900.5 (Ethernet card_B), and slot 6 is shown with a primary SCSI card 900.6 (SCSI card_P). Also shown in FIG. 1 is a peripheral failover controller 600 (PFC), an HSMS 500, a virtual device table 610, a set of virtual devices 700.1-700.4, and a set of drivers 800.1-800.5. To implement a PFS 400 with this system configuration, an SCT might be created with the following six entries:

“Slot01”, “n:192.103.55.225:255.255.255.0”, SYS_CARD_IO_PRI, “Slot05”

“Slot02”, “s”SYS_CARD_10_BKP, “Slot06”

“Slot03”, “sp:9600:8,n,1”, SYS_CARD_IO_PRI, NULL

“Slot04”, “pp”, SYS_CARD_IO_PRI, NULL

“Slot05”, “n:192.103.55.225:255.255.255.0”, SYS_CARD_IO_BKP, “Slot01”

“Slot06”, “s”, SYS_CARD_IO_PRI, “Slot02”

During system initialization, the PFC 600 will read the above SCT and generate a VDT 610 which includes four virtual devices (700.1 through 700.4). Initially, the virtual devices will be assigned to slot 1, slot 3, slot 4, and slot 6, and will connect the I/O devices on these slots to their respective drivers as shown in FIG. 1 in solid lines. As mentioned above, virtual devices will not be created for slots 2 and 5, because these slots have been designated as backup slots in the SCT.

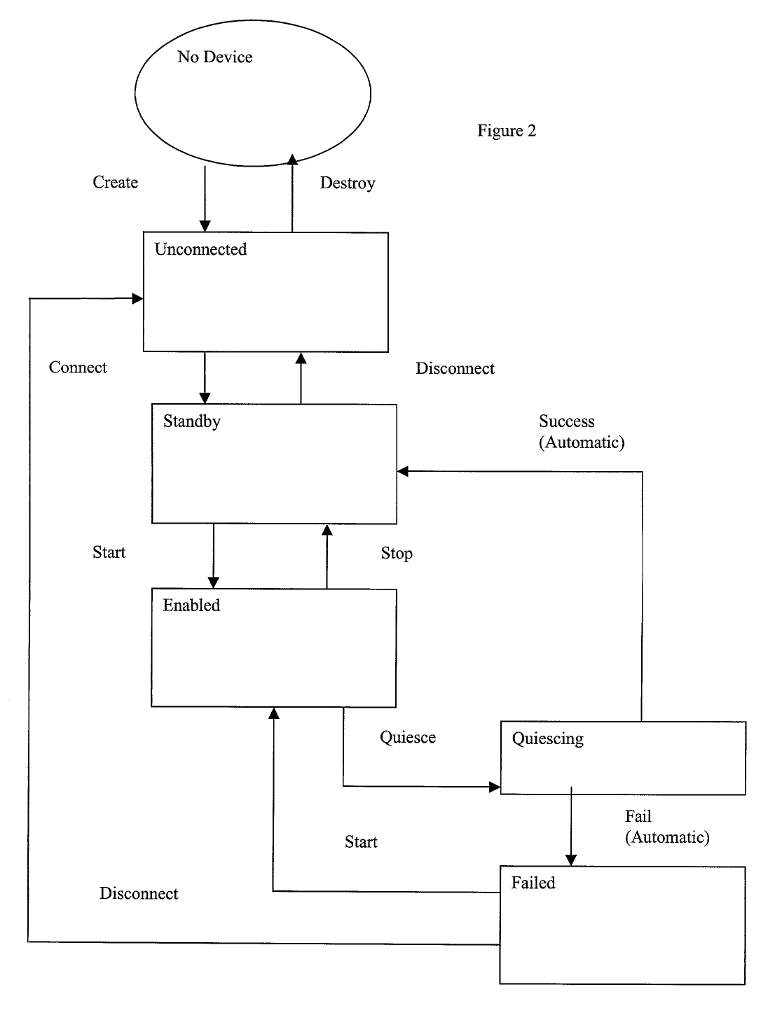

Referring to FIG. 2, a virtual device can be in one of the following states:

1. Unconnected State: the virtual device and virtual driver object have been initialized, but the physical device has not been configured.

2. Standby State: A physical device is attached to the virtual device. A driver (i.e. actual driver) is attached to the virtual device, but the device has not been configured for operation.

3. Enabled State: The virtual device has assumed sole control of the physical device, has configured it as necessary, and is servicing all valid I/O requests.

4. Quiescing state: The virtual device is not accepting new I/O requests, but finishes all output requests that have been accepted. If the virtual device can receive data, the receiver shuts down immediately. When all accepted requests have been completed, the virtual device automatically enters the standby state. If there is a failure in completing this operation then the device automatically enters the failed state.

5. Failed state: The physical device has been flagged as unreliable. However the virtual device continues to behave as if it is in the standby state. Issuing the start command puts it in the enabled state and issuing the disconnect command puts it in the unconnected state. In both cases the failed status is cleared.

The virtual devices will be created and stored in the VDT 610 based upon the information in the SCT, and will initially be in the unconnected state during boot up. The HSMS 500 will call a connect driver function 620 (e.g. sysHsConnectDriver) for devices found on slots 1-6. The called function 620 first checks if the device is of a supported type and, if so, proceeds to find the appropriate virtual device to use for this slot by searching through the VDT 610 for an entry with a matching slot number. Once it finds an unused entry, it determines if the entry corresponds to a primary I/O component. If it does, the function 620 associates the virtual device created for that slot with the I/O component in that slot. It should be noted that there could be multiple virtual devices created per slot since it is possible to have multiple devices in a slot. In that case, the first unused entry of the applicable type is used, and the entry is henceforth marked as used. In any event, the function 620 will identify an appropriate driver for each device in a slot using the information on the physical devices maintained in the VDT. Then it will connect the driver to the physical device through the virtual device.

It should be noted that if the connect driver function 620 is called for a backup slot, then it checks to see if a device is connected in the primary slot. If not, it designates the backup slot as the primary slot and the primary slot as the backup slot. Then it performs the connection procedure outlined above for connecting a primary I/O component. On the other hand, if a device is found connected in the primary slot, then the connect function 620 will note that a device is present in the backup slot but will not attempt to perform any connection procedure.

In the exemplary PFS system 400, when the connect driver function 620 is called for slot 1, it results in the virtual device 700.1 being associated with the physical device 900.1 and a corresponding driver 800.1. Following this, when the connect driver function 620 is called for slot 2, it detects that this is a backup slot and that the primary slot is slot 6. At this point, it checks to see if a device is connected in slot 6. Let us assume, for purposes of this discussion only, that SCSI card_B 900.6 is not present in slot 6. It should be noted that, in certain preferred embodiments of the present invention, the function 620 will always find that no device is present in slot 6 because no connect function 620 has been called for slot 6 at this point in the initialization procedure. The connect function 620 will then designate slot 2 as the primary slot and slot 6 as the backup slot in the VDT and proceed to connect the I/O component using the procedure outlined above for connecting a primary I/O component. In this case, the virtual device 700.4 is associated with physical device 900.2 and the corresponding driver 800.2. The connect driver function 620 is then called for the remaining slots and connect procedures similar to the ones described above are followed.

At this point, the Ethernet card_P 900.1 is connected to the ethernet driver 800.1 via the virtual device 700.1, the SCSI card_B 900.2 is connected to the SCSI driver 800.2 via the virtual device 700.4, the serial port card 900.3 is connected to the serial port driver 800.3 via the virtual device 700.2, and the parallel port 900.4 is connected to the parallel port driver 800.4 via the virtual device 700.3. The devices cannot accept I/O requests at this stage. In order to enable that, the PFC 600 starts the devices, putting them in the enabled state, thus making them operational. Ethernet Card_B 900.5 in slot 5 and SCSI card_P 900.6 have been marked present, but have not been connected to any virtual devices or drivers because they have been designated as backup components.

In any event, let us assume that ethernet card_P 900.1 in slot 1 fails. Upon detecting this failure, the HSMS 500 calls a disconnect driver function 625 (e.g., sysHsDisconnectDriver) for each I/O device on this slot (in this case, only Ethernet card_P 900.1). The function 625 will search through the VDT 610 to locate the virtual device which corresponds to slot 1 (in this case, 700.1). Once the virtual device 700.1 has been identified, the virtual device 700.1 will be put in the quiesced state. During the process of quiescing, the virtual device will stop accepting new I/O requests and complete all pending requests. When all such requests have been completed, the virtual device will automatically move to the standby state. Once this operation completes, the PFC 600 will disconnect the virtual device from the driver 800.1, leaving the virtual device 700.1 in the unconnected state. At this point, the virtual device will be associated with a virtual driver of the appropriate type, in this case the END type.

The PFS will then attempt to failover to the backup device. In this regard, the PFC 600 will determine whether a backup slot is configured for the disconnected slot. If a backup slot is configured, the PFC 600 will check to see if a backup device is present in the backup slot. Assuming that a backup device is present (as in this case), the PFC uses the same virtual device which was used for the primary device to connect to the physical device in the backup slot. To accomplish this failover, the PFS follows a procedure similar to the one described above for initially connecting a backup I/O device. Specifically, the PFC 600 designates the primary slot 01 as the backup and the backup slot 05 as the primary and calls the connect driver function 620 for the I/O device on slot 05. In this case, the connect driver function 620 is called for Ethernet card_B 900.5.

The called function 620 finds the appropriate virtual device to use for the backup I/O device by searching through the virtual device table (VDT) for an entry with a matching slot number (e.g., slot05). Once it finds an unused entry (in this case virtual device 700.1), it checks to see if the entry corresponds to a primary I/O component. In this case it does because slot 05 has been designated as primary. Hence, it associates the virtual device with the I/O component in that slot (in this case Ethernet card_B 900.5). The function 620 then proceeds to find an appropriate driver for this physical device. In this case, the driver is ethernet driver 800.1. The function 620 then connects the physical device (Ethernet card_B 900.5) to the driver 800.1 via the virtual device 700.1, and starts the virtual device 700.1 (placing it in the enabled state). At this point the backup I/O device is operational and failover is complete.

As another example, assume that SCSI card_B 900.2. Upon detecting the failure of SCSI card_B 900.2, the HSMS 500 calls a disconnect driver function 625 (e.g., sysHsDisconnectDriver) for each I/O device on this slot (in this case, only SCSI card_B 900.2). The function 625 will then proceed in the manner described above until SCSI card_B 900.2 is disconnected from the SCSI driver_2 800.2, leaving the virtual device 700.4 in the unconnected state. The PFS will then attempt to failover to the backup device.. In this case, it will identify SCSI card_P 900.6 in the backup slot (slot06) as described above, and then call the connect function 620 (sysHsConnectDriver) for SCSI card_P 900.6. The called function 620 then finds the appropriate virtual device to use for the backup I/O device by searching through the virtual device table (VDT) for an entry with a matching slot number (e.g., slot06). In this case, it will find virtual device 700.4 and associate it with SCSI card_P 900.6 in slot06. The function 620 then proceeds to find an appropriate driver for this physical device. In this case, the driver is SCSI driver_1 800.5. The function 620 then connects the physical device (SCSI card_P 900.6) with SCSI driver_1 800.5, and starts the virtual device 700.4 (placing it in the enabled state). At this point the backup I/O device is operational and failover is complete.

The procedures for implementing a hot swap insertion and hot swap failover will now be described. If an I/O card is inserted into, for example, slot 4, the HSMS 500 detects the insertion and calls the connect driver function 620 (e.g., sysHsConnectDriver) for each I/O device on the inserted card.

In a PCI bus environment, for example, the HSMS 500 could identify multiple devices on a card by examining the PCI configuration space of the inserted device to find out if there are more devices on the card. This is possible, for example, if the device is a PCI-PCI bridge giving access to a PCI bus on the card, on which multiple devices could reside. The HSMS 500 could perform a well-known operation called “PCI walk” to traverse the PCI bus and discover all devices on that bus.

As described above, the called function 620 proceeds to find the appropriate virtual device to use for this physical I/O device by searching through the virtual device table (VDT) for an entry with a matching slot number. Once it finds an unused entry (in this case virtual device 700.3), it checks to see if the entry corresponds to a primary I/O component. In this case it does, and the function 620 proceeds to associate the virtual device with the I/O component found in this slot, which, in this case, is slot 4 virtual device 700.3.

The function 620 then proceeds to find an appropriate driver for this physical device. In this regard, the system maintains a list of registered drivers and their associated physical devices. Moreover, if an appropriate driver is not present, it could be downloaded from a host system, or, for example, the Internet, and registered. In any event, in this case, the function 620 will identify parallel port driver 800.4. The function 620 then connects the physical device 900.4 to the driver 800.4 via the virtual device 700.3, and starts the virtual device 700.3 (the enabled state). At this point the I/O device is configured into the system and is operational. Although a device may be operational in a system, it can become useful only if attached to applications. Therefore, the PFS performs some steps in order to attach the device to the applications above it. Such actions vary from one type of device to another. For example, END (enhanced network device) devices are used by networking protocol stacks, in particular the IP layer and a SCSI device is used by a file system. In the case of END devices, the PFS needs to attach the IP stack to the device driver. For this purpose, the PFS sets the IP address and the netmask for this interface using the parameters specified by the user in the SCT. This results in a fully functional network device in the system. In the case of SCSI devices, some action may, for example, be required to inform the file system of the presence of the new functional SCSI device that has just entered the system.

Continuing with our example, assume that parallel port card 900.4 is subsequently extracted from slot04. The HSMS 500 will detect the extraction event and call a disconnect driver function 625 (e.g. sysHsDisconnectDriver). The function 625 will search through the VDT 610 to locate the virtual device which corresponds to the extracted slot (in this case, slot 4 virtual device 700.3). Once the virtual device 700.3 has been identified, the virtual device 700.3 will be disconnected from the driver 800.4, leaving the virtual device 700.3 in the unconnected state.

The PFC 600 will then attempt to failover to a backup device. In this regard, the PFC 600 will first determine whether a backup slot is configured for the disconnected slot. If a backup slot is configured, the PFS will check to see if a backup device is present in the backup slot. If a backup device is not configured (as in this case) or if no device is present in the backup slot at the time of failover, then PFS leaves the virtual device in the disconnected state. When replacement hardware is inserted into the primary slot (or backup slot if configured), the connection procedure outlined above for connecting a primary or backup I/O component is performed. This completes the hot swap failover procedure.

In accordance with the embodiments of the PFS described above, the “slot” is used to define the I/O components to be failed over, as opposed to the PCI device numbers, or other alternative mechanisms for identifying I/O components. This approach provides a number of advantages.

For example, the use of the slot to identify I/O components provides a convenient mechanism for implementing an I/O Hot Swap. Consider a scenario where a carrier card containing two I/O devices is present on a slot. When one of the I/O devices fails, and a replacement is needed, the entire carrier card would be extracted and both devices on the carrier card would need to be failed over to backup devices. This process is facilitated by identifying the I/O components by their slot numbers.

The use of slots to identify I/O components also allows a user to, for example, failover an ethernet card made by one manufacturer to an ethernet card made by another manufacturer. As shown above, the SCT and VDT 610 identify the I/O components only by slot location and I/O type (e.g. ethernet). When an I/O device is inserted into a slot, the slot name is used to search the table of available virtual devices in the VDT 610. Therefore, as long as the I/O device is of the right type (e.g., ethernet), it will be associated with its corresponding virtual device and become operational even if it is made by a different manufacturer (and different PCI device number) than the I/O device it is replacing. In this regard, the same virtual driver will be used. However, as the driver (i.e., the real, as opposed to virtual driver) will be different for devices made by different manufacturers, the system will attempt to search for the driver for the specific device during the connection procedure as described above. Once the driver is found, the physical device is associated with the virtual device and the driver is associated with the virtual device.

Although the PFS has been described above in conjunction with a Hot Swap Management System, it should be appreciated that other types of failure detection components can alternatively be used. For example, failure detection could be provided by the Failover Management Systems (FMSs) described in copending patent application Ser. No. 09/896,959, filed Jun. 29, 2001, entitled Failover Management System, the entire disclosure of which is hereby incorporated by reference.

In the preceding specification, the invention has been described with reference to specific exemplary embodiments thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. A method comprising the steps of:
identifying a virtual device associated with a first slot of a plurality of slots;
identifying a backup I/O component in a second slot of the plurality of slots; and
disassociating the virtual device with the first slot and associating the virtual device with the second slot.

2. The method of claim 1, wherein, prior to the identifying a virtual device step, the method includes the step of detecting a failure of an I/O component in the first slot.

3. The method of claim 1, wherein
the identifying a virtual device step comprises accessing a virtual device data structure to identify the virtual device associated with the first slot, the virtual device data structure maintaining an association between a plurality of virtual devices and at least a sub-set of the plurality of slots.

4. The method of claim 2, wherein the step of detecting a failure is performed by a Hot Swap Management System.

5. The method of claim 2, wherein the failure is caused by removal of the I/O component from the first slot.

6. The method of claim 1, wherein the step of disassociating comprises:
disassociating the virtual device from a first driver, the first driver being a driver for an I/O component in the first slot;
identifying a second driver, the second driver being a driver for the backup I/O component in the second slot; and
associating the second driver with the virtual device.

7. The method of claim 6, wherein the step of identifying the second driver comprises downloading the second driver from a host system.

8. The method of claim 6, wherein the step of identifying the second driver comprises downloading the second driver from the Internet

9. The method of claim 3, wherein, prior to the identifying a virtual device step, the method comprises the steps of:
generating a system configuration data structure, the system configuration data structure including an entry for each slot of the plurality of slots, each entry including information indicative of an expected I/O device for the corresponding slot and an I/O parameter for the expected I/O device; and
generating the virtual device data structure as a function of the system configuration data structure.

10. The method of claim 9, wherein the I/O parameter includes a plurality of I/O parameters.

11. The method of claim 9, wherein the expected I/O device includes a plurality of expected I/O devices, and wherein the I/O parameter includes one or more I/O parameters for each of the plurality of expected I/O devices.

12. The method of claim 1, wherein the I/O component is one of an ethernet card, a serial port, a parallel port, and an SCSI device.

13. The method of claim 1, wherein the step of disassociating comprises:
disassociating the virtual device from a first driver, the first driver being a driver for an I/O component in the first slot;
associating the virtual device with a virtual driver;
identifying a second driver, the second driver being a driver for the backup I/O component in the second slot;
disassociating the virtual device from the virtual driver; and
associating the second driver with the virtual device.

14. A system comprising:
a virtual device data structure, the virtual device data structure maintaining an association between a plurality of virtual devices and a plurality of slots in a chassis;
a failure detection component, the failure detection component being capable of detecting a failure of an I/O component in one of the plurality of slots;
a disconnect component, the disconnect component being capable of disassociating the I/O component from a corresponding one of the virtual devices associated with the one of the plurality of slots holding the I/O component, and identifying a backup I/O component in another one of the plurality of slots based upon the virtual device data structure;
a connect component, the connect component being capable of associating the corresponding one of the virtual devices with the backup I/O component.

15. The system of claim 14, wherein the failure detection component, the disconnect component and the connect component are implemented in software.

16. The system of claim 14, wherein the failure detection component is a hot swap management system.

17. A system comprising
a plurality of I/O components secured within respective slots in a chassis, at least two of the plurality of I/O components forming a peripheral failover pair;
a peripheral failover system, the peripheral failover system detecting a failure of one I/O component in the peripheral failover pair and disassociating a virtual device from the failed I/O component and associating the virtual device with the other I/O component in the peripheral failover pair.

18. The system of claim 17, wherein the peripheral failover system includes
a virtual device data structure, the virtual device data structure maintaining an association between a plurality of virtual devices and a plurality of slots in the chassis, the plurality of virtual devices including the virtual device;
a failure detection component, the failure detection component being capable of detecting the failure of the one of the I/O components in the peripheral failover pair;
a disconnect component, the disconnect component being capable of disassociating the one of the I/O components from the virtual device, and identifying the other I/O component in the peripheral failover pair based upon the virtual device data structure;
a connect component, the connect component being capable of associating the virtual device with the other I/O component.

19. The system of claim 18, wherein the failure detection component, the disconnect component and the connect component are implemented in software.

20. The system of claim 19, wherein the failure detection component is a hot swap management system.

21. A computer readable medium, having stored thereon, computer executable process steps operative to control a computer to perform steps comprising:
identifying a virtual device associated with a first slot of a plurality of slots;
identifying a backup I/O component in a second slot of the plurality of slots; and
disassociating the virtual device with the first slot and associating the virtual device with the second slot.

22. The computer readable medium of claim 21, wherein, prior to the identifying step, the computer executable process steps are operative to control a computer to detect a failure of an I/O component in the first slot.

23. The computer readable medium of claim 21, wherein
the identifying a virtual device step comprises accessing a virtual device data structure to identify the virtual device associated with the first slot, the virtual device data structure maintaining an association between a plurality of virtual devices and at least a sub-set of the plurality of slots.

24. The computer readable medium of claim 21, wherein the step of disassociating comprises:
disassociating the virtual device from a first driver, the first driver being a driver for an I/O component in the first slot;
identifying a second driver, the second driver being a driver for the backup I/O component in the second slot; and
associating the second driver with the virtual device.

25. The computer readable medium of claim 23, wherein, prior to the identifying a virtual device step, the computer executable process steps are operative to control a computer to perform steps comprising:
generating a system configuration data structure, the system configuration data structure including an entry for each slot of the plurality of slots, each entry including information indicative of an expected I/O device for the corresponding slot and an I/O parameter for the expected I/O device; and
generating the virtual device data structure as a function of the system configuration data structure.

26. The computer readable medium of claim 21, wherein the step of disassociating comprises:
disassociating the virtual device from a first driver, the first driver being a driver for an I/O component in the first slot;
associating the virtual device with a virtual driver;
identifying a second driver, the second driver being a driver for the backup I/O component in the second slot;
disassociating the virtual device from the virtual driver; and
associating the second driver with the virtual device.

27. The computer readable medium of claim 25, wherein the I/O parameter includes a plurality of I/O parameters.

28. The computer readable medium of claim 25, wherein the expected I/O device includes a plurality of expected I/O devices, and wherein the I/O parameter includes one or more I/O parameters for each of the plurality of expected I/O devices.
